(19) United States
(12) Patent Application Publication
(10) Pub. No.: US 2021/0114389 A1
(43) Pub. Date: Apr. 22, 2021

(54) PRINT CARTRIDGE, TAPE GUIDE, AND PRINTING DEVICE

(71) Applicant: SEIKO EPSON CORPORATION, Tokyo (JP)

(72) Inventors: Taishi SASAKI, Matsumoto-shi (JP); Akio ISHIMOTO, Shiojiri-shi (JP)

(73) Assignee: SEIKO EPSON CORPORATION, Tokyo (JP)

(21) Appl. No.: 17/042,226

(22) PCT Filed: Mar. 1, 2019
(86) PCT No.: PCT/JP2019/008051

§ 371 Date: Sep. 28, 2020

(30) Foreign Application Priority Data
Mar. 29, 2018 (JP) 2018-063683

(51) Int. Cl. B41J 32/02

(52) U.S. Cl. CPC B41J 32/02

(57) ABSTRACT

A print cartridge mounted in a printing device including a cartridge mounting portion and a substrate connecting portion having an elastic contact portion elastically displaceable in a first direction and in the cartridge mounting portion, and a receiving portion in the cartridge mounting portion and, located along the first direction with respect to the substrate connecting portion, the print cartridge includes cartridge case, a substrate attaching portion in the cartridge case, a circuit substrate attached to the substrate attaching portion, located between the substrate connecting portion and receiving portion, brought into contact with the elastic contact portion, and pressed to the receiving portion side by an elastic force of the elastic contact portion in the first direction when the print cartridge is mounted in the cartridge mounting portion, and a receiving contact portion located between the circuit substrate and the receiving portion and comes into contact with the receiving portion.

### TECHNICAL FIELD

The present invention relates to a print cartridge that accommodates a tape-shaped member, a tape guide that guides the tape-shaped member, a printing device in which the print cartridge is mounted, and a printing device in which the tape guide is mounted.

### BACKGROUND ART

In the related art, as disclosed in PTL 1, an ink cartridge to which a circuit substrate is attached is known. A substrate connecting portion is provided in the cartridge mounting portion, and when the ink cartridge is mounted in the cartridge mounting portion, the substrate connecting portion and the circuit substrate are connected. Further, as disclosed in PTL 2, there is known a printing device that uses a ribbon cassette accommodating an ink ribbon when performing printing on a long print medium such as a tube. In such a printing device, a circuit substrate similar to the circuit substrate disclosed in PTL 1 may be attached to the ribbon cassette in order to manage the use amount and the like of the ink ribbon accommodated in the ribbon cassette.

### CITATION LIST

### Patent Literature

PTL 1: JP-A-2013-129175

PTL 2: JP-A-2017-019218

### SUMMARY OF INVENTION

### Technical Problem

As the substrate connecting portion provided in the cartridge mounting portion, it is possible to use one having an elastic contact portion capable of elastic displacement. However, in this configuration, when the print cartridge is mounted in the cartridge mounting portion, the circuit substrate is pressed by the elastic force of the elastic contact portion, and there is a possibility that the cartridge case to which the rotating substrate is attached is mounted in a tilted posture with respect to the bottom surface of the cartridge mounting portion. Further, like the printing device disclosed in PTL 2, it is conceivable to use a case-shaped tape guide to which a circuit substrate is attached in order to manage the use amount and the like of a long print medium introduced from the outside of the printing device. Such a tape guide also has the same problem as the above-described print cartridge.

The present invention has at least one of the following objects.

An object of the present invention to provide a print cartridge and a printing device capable of properly mounting a print cartridge to which a circuit substrate is attached in a cartridge mounting portion.

Another object of the present invention is to provide a tape guide and a printing device that can properly mount a tape guide to which a circuit substrate is attached in a guide mounting portion.

### Solution to Problem

A print cartridge of the present invention is a print cartridge to be mounted in a printing device including a cartridge mounting portion in which the print cartridge is mounted, a substrate connecting portion having an elastic contact portion that is elastically displaceable in a first direction and provided in the cartridge mounting portion, and a receiving portion provided in the cartridge mounting portion and located above the substrate connecting portion in the first direction, the print cartridge including: a cartridge case accommodating a tape-shaped member; a substrate attaching portion provided on the cartridge case; a circuit substrate that is attached to the substrate attaching portion, is located between the substrate connecting portion and the receiving portion, is brought into contact with the elastic contact portion, and is pressed to the receiving portion side by an elastic force of the elastic contact portion in the first direction when the print cartridge is mounted in the cartridge mounting portion; and a receiving contact portion that is located between the circuit substrate and the receiving portion and comes into contact with the receiving portion in the first direction when the print cartridge is mounted in the cartridge mounting portion.

A tape guide of the present invention is a tape guide mounted in a printing device including a guide mounting portion in which the tape guide is mounted, a substrate connecting portion having an elastic contact portion that is elastically displaceable in a first direction and provided in the guide mounting portion, and a receiving portion located along the first direction with respect to the substrate connecting portion and provided in the guide mounting portion, the tape guide including: a guide portion for guiding the tape-shaped member; a substrate attaching portion; a circuit substrate that is attached to the substrate attaching portion, is located between the substrate connecting portion and the receiving portion, is brought into contact with the elastic contact portion, and is pressed to the receiving portion side by an elastic force of the elastic contact portion in the first direction when the tape guide is mounted in the guide mounting portion; and a receiving contact portion that is located between the circuit substrate and the receiving portion and comes into contact with the receiving portion in the first direction when the tape guide is mounted in the guide mounting portion.

A printing device of the present invention is a printing device in which a print cartridge with a cartridge case accommodating a tape-shaped member, a substrate attaching portion provided in the cartridge case, a circuit substrate attached to the substrate attaching portion, and a receiving contact portion provided along a first direction with respect to the circuit substrate, the printing device including: a cartridge mounting portion in which the print cartridge is mounted; a substrate connecting portion having an elastic contact portion that is elastically displaceable in the first direction, provided in the cartridge mounting portion, and pressing the circuit substrate toward the receiving contact portion side in the first direction by an elastic force of the elastic contact portion that comes into contact with the circuit substrate in the first direction when the print cartridge is mounted in the cartridge mounting portion; and a receiving portion that receives the receiving contact portion that is pushed by the elastic force of the elastic contact portion in the first direction when the print cartridge is mounted in the cartridge mounting portion.

Another printing device of the present invention is a printing device in which a tape guide with a guide portion for guiding a tape-shaped member, a substrate attaching portion, a circuit substrate attached to the substrate attaching portion, and a receiving contact portion provided along a first direction with respect to the circuit substrate, the printing device including: a guide mounting portion in which the tape guide is mounted; a substrate connecting portion having an elastic contact portion that is elastically displaceable in the first direction and provided in the guide mounting portion so as to push the circuit substrate toward the receiving contact portion side in the first direction by an elastic force of the elastic contact portion that comes into contact with the circuit substrate in the first direction when the tape guide is mounted in the guide mounting portion; and a receiving portion that receives the receiving contact portion that is pressed by the elastic force of the elastic contact portion in the first direction when the tape guide is mounted in the guide mounting portion.

### BRIEF DESCRIPTION OF DRAWINGS

FIG. 1 is a perspective view of a tape printing device in which a ribbon cartridge and a tape guide according to an embodiment of the present invention are mounted.

FIG. 2 is a view of the tape printing device in which the ribbon cartridge and the tape guide are mounted, as seen from the front side in the mounting direction.

FIG. 3 is a view of the tape printing device with a tape cartridge mounted, as seen from the front side in the mounting direction.

FIG. 4 is a view of the tape printing device as seen from the front side in the mounting direction.

FIG. 5 is a perspective view of the ribbon cartridge.

FIG. 6 is a view of the ribbon cartridge as seen from the front side in the mounting direction.

FIG. 7 is a view of the ribbon cartridge as seen from the −Y side.

FIG. 8 is a view of the ribbon cartridge as seen from the +Y side.

FIG. 9 is a perspective view of the ribbon cartridge with a front side case removed.

FIG. 10 is a view of the ribbon cartridge with the front side case removed, as seen from the front side in the mounting direction.

FIG. 11 is a view of a back side case as seen from the front side in the mounting direction.

FIG. 12 is a partially enlarged perspective view of the back side case, showing the configuration around a substrate attaching portion and a receiving insertion portion.

FIG. 13 is a partially enlarged view of the back side case as seen from the −Y side, showing the configuration around the substrate attaching portion and the receiving insertion portion.

FIG. 14 is a partial enlarged view of the back side case as seen from the front side in the mounting direction, showing the configuration around the substrate attaching portion and the receiving insertion portion.

FIG. 15 is a partial enlarged cross-sectional view of the ribbon cartridge case and the second cartridge mounting portion, showing the configuration around the substrate attaching portion and the receiving insertion portion.

### DESCRIPTION OF EMBODIMENTS

Hereinafter, a ribbon cartridge 200 that is an embodiment of a “print cartridge” of the present invention and a tape printing device P that is an embodiment of a “printing device” of the present invention will be described with reference to the accompanying drawings. In the following drawings, an XYZ orthogonal coordinate system is shown in order to clarify the arrangement relationship of each portion, but it goes without saying that it does not limit the present invention in any way.

### [Tape Printing Device]

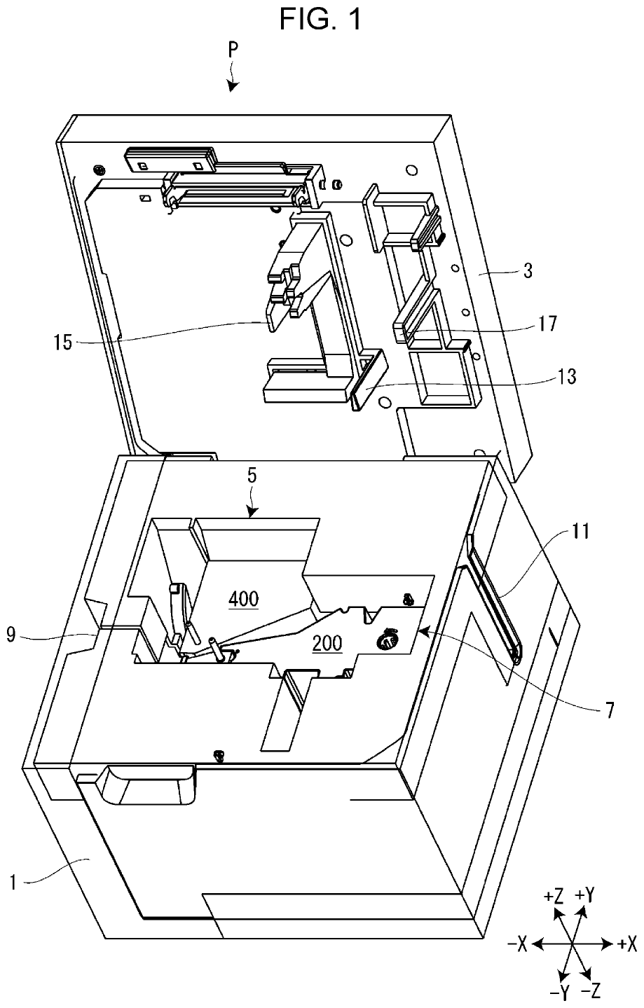

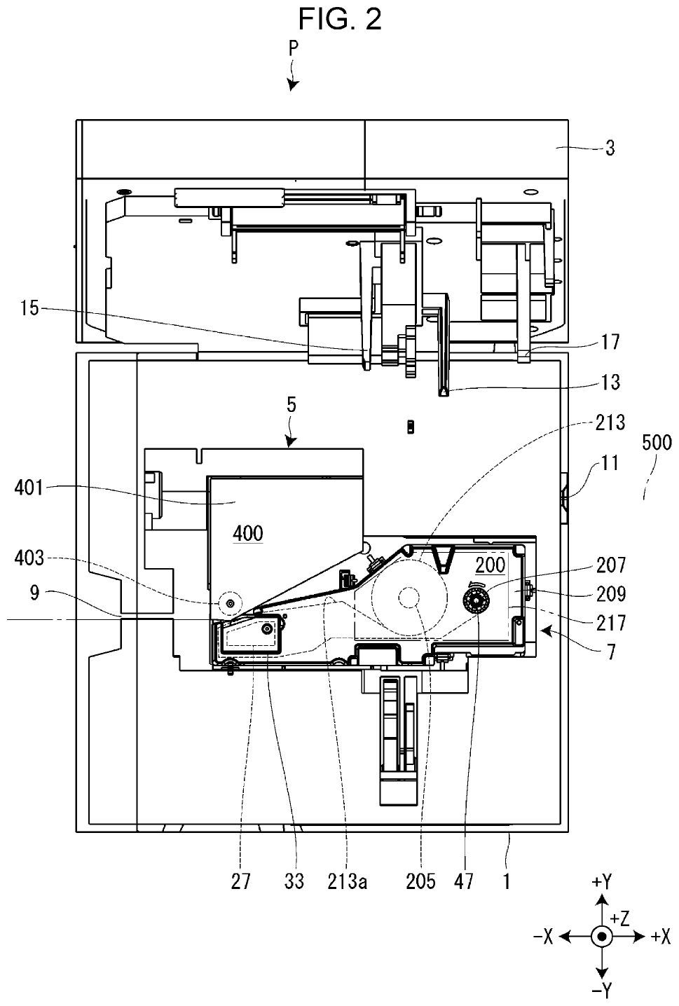

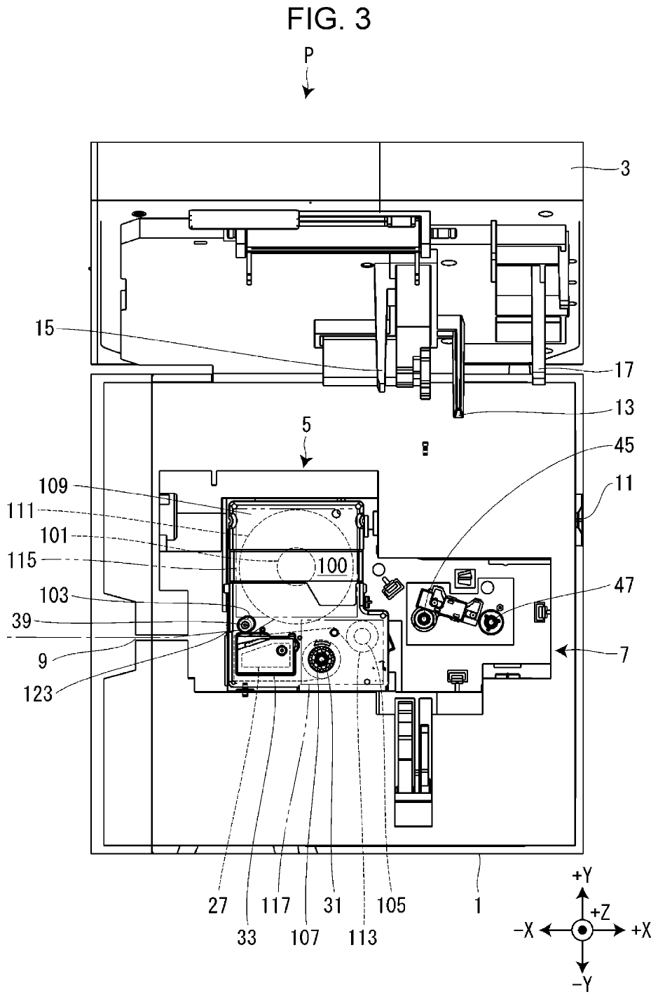

The tape printing device P will be described with reference to FIGS. 1 to 4. A tape cartridge 100, the ribbon cartridge 200, and a tape guide 400 are detachably mounted in the tape printing device P. A first tape 111 and a first ink ribbon 113 are accommodated in the tape cartridge 100. A second ink ribbon 213 is accommodated in the ribbon cartridge 200. The second ink ribbon 213 is an example of the “tape-shaped member” of the present invention. Further, the tape printing device P is provided with a tape introduction port 11 for introducing a second tape 500 from outside the tape printing device P. The tape guide 400 guides the second tape 500 introduced from the tape introduction port 11. The tape printing device P can execute first tape printing for performing printing on the first tape 111 with the tape cartridge 100 mounted as shown in FIG. 3 and second tape printing for performing printing on the second tape 500 with the ribbon cartridge 200 and the tape guide 400 mounted as shown in FIGS. 1 and 2.

The tape printing device P includes a device case 1, a mounting portion cover 3, a first cartridge mounting portion 5, and a second cartridge mounting portion 7. The device case 1 is formed in a substantially rectangular parallelepiped shape. The device case 1 is provided with a tape discharge port 9 on the −X side surface and a tape introduction port 11 on the +X side surface. The printed first tape 111 or the printed second tape 500 is discharged from the tape discharge port 9. The second tape 500 is introduced into the tape introduction port 11 from outside the tape printing device P.

The mounting portion cover 3 is provided on the device case 1 so as to be rotatable around the +Y side end portion. The mounting portion cover 3 opens and closes the first cartridge mounting portion 5 and the second cartridge mounting portion 7. The mounting portion cover 3 is locked in a closed state by a cover lock mechanism (not shown). Then, when a cover open button (not shown) is pressed, the cover lock mechanism is unlocked and the mounting portion cover 3 is opened.

A first pressing projection 13, a second pressing projection 15, and a third pressing projection 17 are provided on the inner surface of the mounting portion cover 3 so as to project. When the mounting portion cover 3 is closed with the ribbon cartridge 200 mounted in the second cartridge mounting portion 7, the first pressing projection 13, the second pressing projection 15, and the third pressing projection 17 abut on the ribbon cartridge 200. Therefore, the ribbon cartridge 200 is mounted in a state of being pressed by the first pressing projection 13, the second pressing projection 15, and the third pressing projection 17.

Although not shown, a keyboard and a display are provided on the outer surface of the mounting portion cover 3. The keyboard receives print information such as a character string and an input operation of various instructions such as print execution. The display displays various information in addition to the print information input from the keyboard. When the keyboard receives a print execution input operation, the tape printing device P executes print processing based on the print information input from the keyboard. The tape printing device P may be configured to include input display means such as a touch panel display instead of the keyboard and the display. Further, the tape printing device P may be configured to execute print processing based on print data and commands received from an external device such as a personal computer or a smartphone. The keyboard and the display may or may not be provided when connecting to these external devices.

The first cartridge mounting portion 5 and the second cartridge mounting portion 7 are provided on the +Z side surface of the device case 1. The tape cartridge 100 is detachably mounted in the first cartridge mounting portion 5. The ribbon cartridge 200 is detachably mounted in the second cartridge mounting portion 7. The second cartridge mounting portion 7 is an example of the “cartridge mounting portion” of the present invention. The first cartridge mounting portion 5 and the second cartridge mounting portion 7 are formed in a concave shape in which the +Z side is opened. Therefore, the tape cartridge 100 and the ribbon cartridge 200 are mounted in the first cartridge mounting portion 5 and the second cartridge mounting portion 7, respectively, from the +Z side. Hereinafter, the mounting directions of the tape cartridge 100 and the ribbon cartridge 200 are simply referred to as “mounting directions”. Further, the front side in the mounting direction means the +Z side, and the back side in the mounting direction means the −Z side.

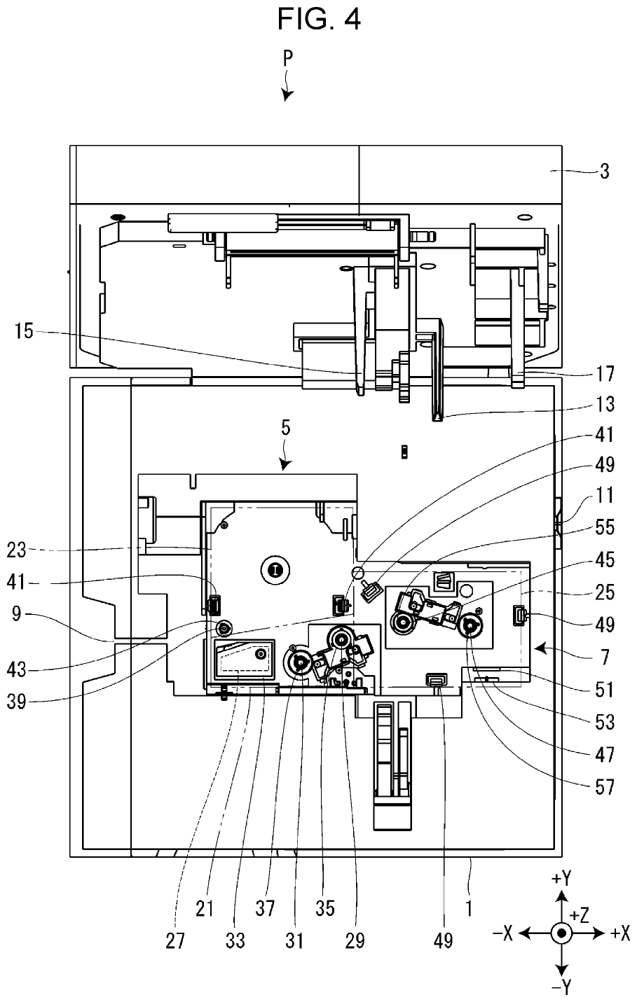

As shown in FIG. 4, the −Y side portion of the first cartridge mounting portion 5 and the −X side portion of the second cartridge mounting portion 7 are commonized. Here, the portion where the first cartridge mounting portion 5 and the second cartridge mounting portion 7 overlap is referred to as an overlapping region 21. Further, a portion of the first cartridge mounting portion 5 which is out of the overlapping region 21 is referred to as a first non-overlapping region 23, and a portion of the second cartridge mounting portion 7 which is out of the overlapping region 21 is referred to as a second non-overlapping region 25. The first non-overlapping region 23 functions as a guide mounting portion to which the tape guide 400 is detachably mounted. In this way, since the first cartridge mounting portion 5 and the second cartridge mounting portion 7 are partly commonized, the tape printing device P can be downsized as compared with the structure in which the first cartridge mounting portion 5 and the second cartridge mounting portion 7 are separately provided.

As shown in FIG. 3, at the time of the first tape printing, the tape cartridge 100 is mounted in the first cartridge mounting portion 5. In this state, the tape printing device P performs printing on the first tape 111 while feeding the first tape 111 and the first ink ribbon 113 accommodated in the tape cartridge 100.

As shown in FIGS. 1 and 2, at the time of the second tape printing, the tape guide 400 is mounted in the first cartridge mounting portion 5, and the ribbon cartridge 200 is mounted in the second cartridge mounting portion 7. In this state, the tape printing device P performs printing on the second tape 500 while feeding the second tape 500 introduced from the tape introduction port 11 and the second ink ribbon 213 accommodated in the ribbon cartridge 200.

The second tape 500 is provided as, for example, a tape roll wound in a roll shape. The length of the second tape 500 in the unused tape roll and the length of the second ink ribbon 213 accommodated in the ribbon cartridge 200 are not particularly limited. However, in the present embodiment, they are longer than the length of the first tape 111 and the length of the first ink ribbon 113 accommodated in the unused tape cartridge 100. Therefore, for example, when a large number of labels are created at one time, the second tape printing is executed.

### [Tape Cartridge]

The tape cartridge 100 will be described with reference to FIG. 3. The tape cartridge 100 includes a tape core 101, a first platen roller 103, a first paying-out core 105, a first winding core 107, and a first cartridge case 109 that rotatably accommodates these. A first tape 111 is wound around the tape core 101. A first ink ribbon 113 is wound around the first paying-out core 105 with the surface coated with ink inside. There are a plurality of types of the first cartridge case 109, which have different thicknesses, that is, dimensions in the mounting direction, depending on the widths of the first tape 111 and the first ink ribbon 113 accommodated therein.

The first cartridge case 109 is formed in a substantially “L” shape when seen from the front side in the mounting direction. A tape core accommodating portion 115 is provided at a substantially half portion on the +Y side of the first cartridge case 109. The tape core 101 is rotatably accommodated in the tape core accommodating portion 115.

Of the approximately −Y side half portion of the first cartridge case 109, the first ribbon core accommodating portion 117 is provided on the +X side, and the first head insertion portion (not shown) is provided on the −X side. The first paying-out core 105 and the first winding core 107 are rotatably accommodated in the first ribbon core accommodating portion 117. The first head insertion portion, the first paying-out core 105, and the first winding core 107 are respectively provided at positions corresponding to a thermal head 27, a first paying-out shaft 29, and a first winding shaft 31 (see FIG. 4) provided in the overlapping region 21. The thermal head 27 is inserted into the first head insertion portion when the tape cartridge 100 is mounted in the first cartridge mounting portion 5. A first ribbon exposing portion (not shown) for exposing the first ink ribbon 113 is provided at the peripheral edge portion of the first head insertion portion. The first ink ribbon 113 fed from the first paying-out core 105 passes through the first ribbon exposing portion and is wound around the first winding core 107.

A tape delivery port 123 is provided on the −X side surface of the first cartridge case 109. The printed first tape 111 is sent out of the first cartridge case 109 from the tape delivery port 123. Although not shown in the drawings, a first hook engaging portion is provided on the +X side surface and the −X side surface of the first cartridge case 109.

### [Outline of Ribbon Cartridge]

An outline of the ribbon cartridge 200 will be described with reference to FIG. 2. The ribbon cartridge 200 includes a second paying-out core 205, a second winding core 207, and a second cartridge case 209 that rotatably accommodates these. A second ink ribbon 213 is wound around the second paying-out core 205 with the surface coated with the ink inside. Hereinafter, the surface of the second ink ribbon 213 coated with ink is referred to as an ink surface 213a. There are a plurality of types of the second cartridge case 209 having different thicknesses depending on the width of the accommodated second ink ribbon 213.

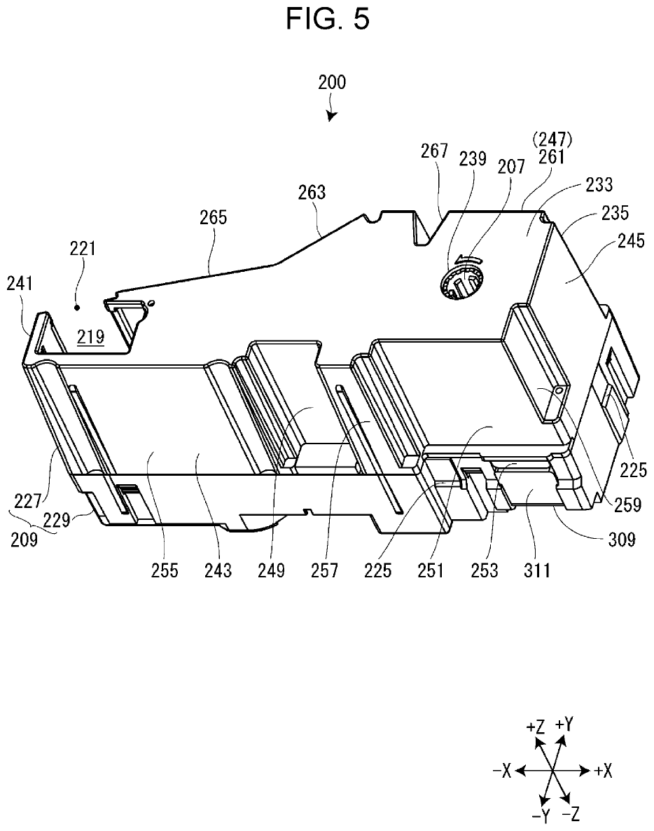

The second cartridge case 209 is formed in a substantially rectangular shape that is long in the X direction when viewed from the front side in the mounting direction. A second ribbon core accommodating portion 217 is provided on the +X side of the second cartridge case 209, and a second head insertion portion 219 (see FIG. 5) is provided on the −X side. The second paying-out core 205 and the second winding core 207 are rotatably accommodated in the second ribbon core accommodating portion 217. The second head insertion portion 219, the second paying-out core 205, and the second winding core 207 are respectively provided at positions corresponding to the thermal head 27 provided in the overlapping region 21 and a second paying-out shaft 45 (See FIG. 4) and a second winding shaft 47 provided in the second non-overlapping region 25. The second ink ribbon 213 is wound around the second paying-out core 205, and the second ink ribbon 213 is wound around the second winding core 207. Therefore, the center of gravity of the ribbon cartridge 200 is located closer to the second ribbon core accommodating portion 217 that accommodates the second paying-out core 205 and the second winding core 207, that is, closer to the +X side. The second cartridge case 209 is an example of the “cartridge case” of the present invention.

The thermal head 27 is inserted into the second head insertion portion 219 when the ribbon cartridge 200 is mounted in the second cartridge mounting portion 7. A second ribbon exposing portion 221 (see FIG. 5) for exposing the second ink ribbon 213 is provided at the peripheral edge portion of the second head insertion portion 219. The second ink ribbon 213 fed from the second paying-out core 205 passes through the second ribbon exposing portion 221 and is wound around the second winding core 207. Further, a second hook engaging portion 225 is provided on the −Y side surface, the +X side surface, and the +Y side surface of the second cartridge case 209 (see FIGS. 5 and 7 to 9).

### [Tape Guide]

The tape guide 400 will be described with reference to FIG. 2. The tape guide 400 is formed in a case shape and includes a roller support portion 401 and a second platen roller 403. The roller support portion 401 rotatably supports the second platen roller 403. There are a plurality of types of the tape guide 400 having different thicknesses depending on the width of the second tape 500 to be guided.

### [Cartridge Mounting Portion]

The first cartridge mounting portion 5 and the second cartridge mounting portion 7 will be described with reference to FIG. 4. As described above, the first cartridge mounting portion 5 and the second cartridge mounting portion 7 can be divided into the overlapping region 21, the first non-overlapping region 23, and the second non-overlapping region 25.

The thermal head 27, the first paying-out shaft 29, and the first winding shaft 31 are provided on the bottom surface of the overlapping region 21, that is, the surface on the back side of the overlapping region 21 in the mounting direction so as to project toward the front side in the mounting direction. Although not shown, a cutter is provided between the thermal head 27 and the tape discharge port 9. The cutter cuts the first tape 111 or the second tape 500 at a position between the thermal head 27 and the tape discharge port 9.

The thermal head 27 is covered by a head cover 33. When the tape cartridge 100 is mounted in the first cartridge mounting portion 5, the head cover 33 is inserted into the first head insertion portion. Further, when the ribbon cartridge 200 is mounted in the second cartridge mounting portion 7, the head cover 33 is inserted into the second head insertion portion 219.

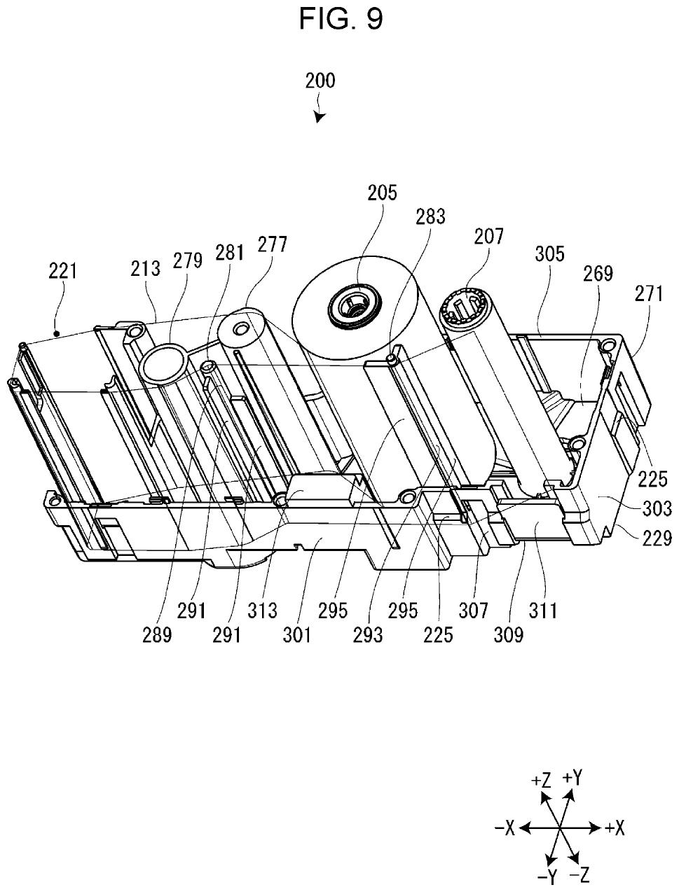

A first paying-out rotation member 35 is rotatably provided on the first paying-out shaft 29. The first paying-out shaft 29 is inserted into the first paying-out core 105 when the tape cartridge 100 is mounted in the first cartridge mounting portion 5, and the first paying-out rotation member 35 is engaged with the first paying-out core 105. Further, the first paying-out shaft 29 is inserted into the paying-out side cylinder portion 277 (see FIG. 9) provided in the ribbon cartridge 200 when the ribbon cartridge 200 is mounted in the second cartridge mounting portion 7.

A first winding rotation member 37 is rotatably provided on the first winding shaft 31. The first winding shaft 31 is inserted into the first winding core 107 when the tape cartridge 100 is mounted in the first cartridge mounting portion 5, and the first winding rotation member 37 is engaged with the first winding core 107. Further, the first winding shaft 31 is inserted into the winding side cylinder portion 279 (see FIG. 9) provided in the ribbon cartridge 200 when the ribbon cartridge 200 is mounted in the second cartridge mounting portion 7.

A platen shaft 39 and two first hooks 41 are provided on the bottom surface of the first non-overlapping region 23 so as to project toward the front side in the mounting direction.

A platen rotation member 43 is rotatably provided on the platen shaft 39. The platen shaft 39 is inserted into the first platen roller 103 when the tape cartridge 100 is mounted in the first cartridge mounting portion 5, and the platen rotation member 43 is engaged with the first platen roller 103. Further, the platen shaft 39 is inserted into the second platen roller 403 when the tape guide 400 is mounted in the first non-overlapping region 23, and the platen rotation member 43 is engaged with the second platen roller 403.

The two first hooks 41 are provided at both end portions of the first non-overlapping region 23 in the X direction and are engaged with the first hook engaging portion provided in the first cartridge case 109 when the tape cartridge 100 is mounted in the first cartridge mounting portion 5. As a result, the tape cartridge 100 is prevented from being mounted in a state of floating from the bottom surface of the first cartridge mounting portion 5.

A second paying-out shaft 45, the second winding shaft 47, three second hooks 49, and a receiving portion 51 are provided on the bottom surface of the second non-overlapping region 25 so as to project toward the front side in the mounting direction. Further, the substrate connecting portion 53 is fixed to the −Y side inner peripheral surface of the second non-overlapping region 25.

A second paying-out rotation member 55 is rotatably provided on the second paying-out shaft 45. The second paying-out shaft 45 is inserted into the second paying-out core 205 when the ribbon cartridge 200 is mounted in the second cartridge mounting portion 7, and the second paying-out rotation member 55 is engaged with the second paying-out core 205.

A second winding rotation member 57 is rotatably provided on the second winding shaft 47. The second winding shaft 47 is inserted into the second winding core 207 when the ribbon cartridge 200 is mounted in the second cartridge mounting portion 7, and the second winding rotation member 57 is engaged with the second winding core 207.

The three second hooks 49 are provided so as to surround the second paying-out shaft 45 and the second winding shaft 47. The second hook 49 is engaged with the second hook engaging portion 225 provided on the second cartridge case 209 when the ribbon cartridge 200 is mounted in the second cartridge mounting portion 7.

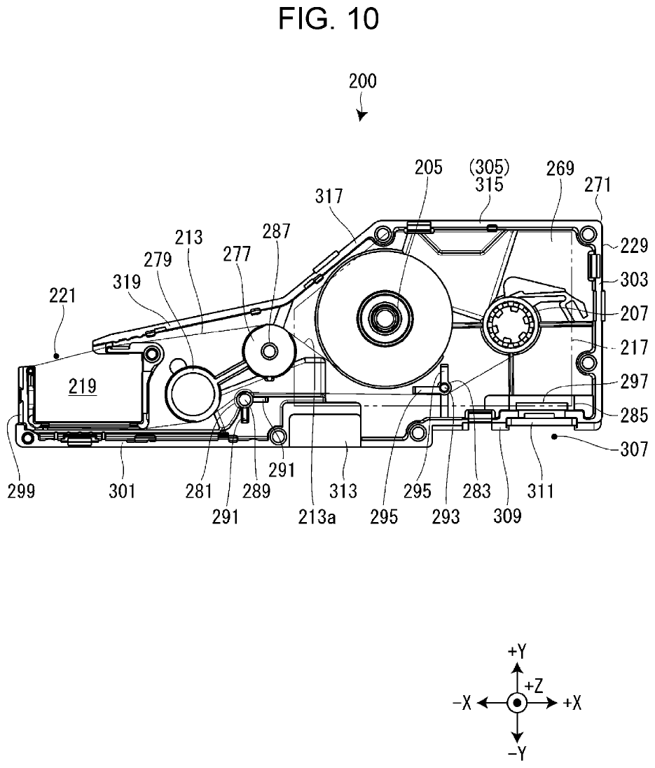

The receiving portion 51 is located and provided at a +X side and −Y side corner of the second cartridge mounting portion 7. The receiving portion 51 is inserted into a receiving insertion hole 297 (see FIG. 10) provided in the second cartridge case 209 when the ribbon cartridge 200 is mounted in the second cartridge mounting portion 7.

The substrate connecting portion 53 is provided at the +X side end portion in the −Y side inner peripheral surface of the second cartridge mounting portion 7. That is, the substrate connecting portion 53 is provided on the −Y side of the receiving portion 51. The substrate connecting portion 53 is connected to a control circuit (not shown) included in the tape printing device P. The substrate connecting portion 53 is connected to a circuit substrate 311 (see FIG. 5) included in the ribbon cartridge 200 when the ribbon cartridge 200 is mounted in the second cartridge mounting portion 7. Thereby, the control circuit can read various information stored in the circuit substrate 311 and can write various information in the circuit substrate 311.

In the tape printing device P configured as above, when the tape cartridge 100 is mounted in the first cartridge mounting portion 5 for the first tape printing, the platen rotation member 43, the first paying-out rotation member 35, and the first winding rotation member 37 are engaged with the first platen roller 103, the first paying-out core 105, and the first winding core 107, respectively. Then, when the mounting portion cover 3 is closed, the head moving mechanism (not shown) moves the thermal head 27 toward the platen shaft 39. As a result, the first ink ribbon 113 exposed at the first ribbon exposing portion is nipped between the thermal head 27 and the first platen roller 103 together with the first tape 111.

When the feed motor (not shown) rotates in the forward direction in this state, the driving force of the feed motor is transmitted to the platen rotation member 43, the first winding rotation member 37, and the second winding rotation member 57. Then, the first platen roller 103 engaged with the platen rotation member 43 rotates clockwise when viewed from the front side in the mounting direction, and the first winding core 107 engaged with the first winding rotation member 37 rotates counterclockwise when viewed from the front side in the mounting direction. As a result, the first tape 111 fed from the tape core 101 is fed toward the tape discharge port 9, and the first ink ribbon 113 fed from the first paying-out core 105 is wound around the first winding core 107. At this time, the second winding rotation member 57 is in the idle state.

When the feed motor rotates in the return direction opposite to the forward direction, the driving force of the feed motor is transmitted to the platen rotation member 43, the first paying-out rotation member 35, and the second paying-out rotation member 55. Then, the first platen roller 103 engaged with the platen rotation member 43 rotates counterclockwise when viewed from the front side in the mounting direction, and the first paying-out core 105 engaged with the first paying-out rotation member 35 rotates counterclockwise when viewed from the front side in the mounting direction. As a result, the first tape 111 fed from the tape core 101 is fed toward the tape core 101, and the first ink ribbon 113 fed from the first paying-out core 105 is rewound onto the first paying-out core 105. At this time, the second paying-out rotation member 55 is in the idle state.

At the time of the first tape printing, the tape printing device P feeds the first tape 111 toward the tape discharge port 9 by rotating the feed motor in the forward direction and performs printing on the first tape 111 by heating the thermal head 27 while winding the first ink ribbon 113 onto the first winding core 107. After the printing is completed, the tape printing device P causes the cutter to perform a cutting operation to cut off the printed portion of the first tape 111. After that, the tape printing device P rotates the feed motor in the return direction to feed the first tape 111 toward the tape core 101 and rewinds the first ink ribbon 113 onto the first paying-out core 105. As a result, the first tape 111 is pulled back until the front end of the first tape 111 comes close to the nipping position between the thermal head 27 and the first platen roller 103, that is, near the printing position. For this reason, in the first tape 111 to be printed next, it is possible to shorten the blank space generated at the front of the first tape 111 in the length direction due to the distance between the thermal head 27 and the cutter.

On the other hand, when the ribbon cartridge 200 is mounted in the second cartridge mounting portion 7 for the second tape printing, the second paying-out rotation member 55 and the second winding rotation member 57 are engaged with the second paying-out core 205 and the second winding core 207, respectively. Further, when the tape guide 400 is mounted in the first non-overlapping region 23, the platen rotation member 43 is engaged with the second platen roller 403. The second tape 500 introduced from the tape introduction port 11 is set in the tape guide 400. Then, when the mounting portion cover 3 is closed, the thermal head 27 moves toward the platen shaft 39. As a result, the second ink ribbon 213 exposed at the second ribbon exposing portion 221 is nipped between the thermal head 27 and the second platen roller 403 together with the second tape 500.

When the feed motor rotates in the forward direction in this state, the driving force of the feed motor is transmitted to the platen rotation member 43, the first winding rotation member 37, and the second winding rotation member 57. Then, the second platen roller 403 engaged with the platen rotation member 43 rotates clockwise when viewed from the front side in the mounting direction, and the second winding core 207 engaged with the second winding rotation member 57 rotates counterclockwise when viewed from the front side in the mounting direction. As a result, the second tape 500 introduced from the tape introduction port 11 is fed toward the tape discharge port 9, and the second ink ribbon 213 fed from the second paying-out core 205 is wound around the second winding core 207. At this time, the first winding rotation member 37 is in the idle state.

When the feed motor rotates in the return direction, the driving force of the feed motor is transmitted to the platen rotation member 43, the first paying-out rotation member 35, and the second paying-out rotation member 55. Then, the second platen roller 403 engaged with the platen rotation member 43 rotates counterclockwise when viewed from the front side in the mounting direction, and the second paying-out core 205 engaged with the second paying-out rotation member 55 rotates counterclockwise when viewed from the front side in the mounting direction. As a result, the second tape 500 introduced from the tape introduction port 11 is fed toward the tape introduction port 11, and the second ink ribbon 213 fed from the second paying-out core 205 is rewound onto the second paying-out core 205. At this time, the first paying-out rotation member 35 is in the idle state.

At the time of the second tape printing, as at the time of the first tape printing, the tape printing device P feeds the second tape 500 toward the tape discharge port 9 by rotating the feed motor in the forward direction and performs printing on the second tape 500 by heating the thermal head 27 while winding the second ink ribbon 213 onto the second winding core 207. After the printing is completed, the tape printing device P causes the cutter to perform a cutting operation to cut off the printed portion of the second tape 500. After that, the tape printing device P rotates the feed motor in the return direction to feed the second tape 500 toward the tape introduction port 11 and rewinds the second ink ribbon 213 onto the second paying-out core 205. As a result, the second tape 500 is pulled back until the front end of the second tape 500 comes close to the nipping position between the thermal head 27 and the second platen roller 403, that is, near the printing position. For this reason, in the second tape 500 to be printed next, it is possible to shorten the blank space generated at the front of the second tape 500 in the length direction due to the distance between the thermal head 27 and the cutter.

### [Details of Ribbon Cartridge]

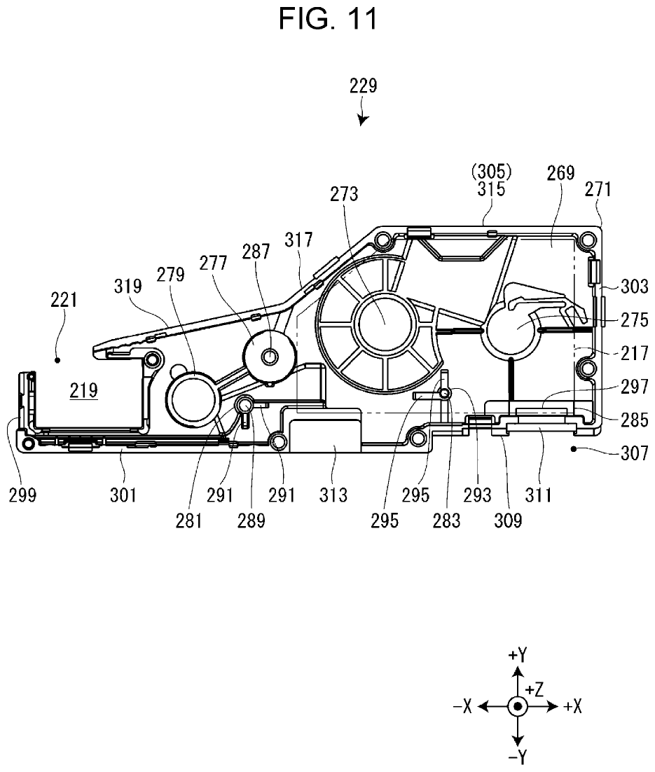

The ribbon cartridge 200 will be further described with reference to FIGS. 5 to 11. As shown in FIG. 5, the second cartridge case 209 includes a front side case 227 and a back side case 229. The front side case 227 is on the front side in the mounting direction when the ribbon cartridge 200 is mounted in the second cartridge mounting portion 7. The back side case 229 becomes the back side in the mounting direction when the ribbon cartridge 200 is mounted in the second cartridge mounting portion 7. The front side case 227 is a resin molded product having a light-transmitting property, and the back side case 229 is a resin molded product having no light-transmitting property. However, the material and the manufacturing method of the front side case 227 and the back side case 229 are not limited to this.

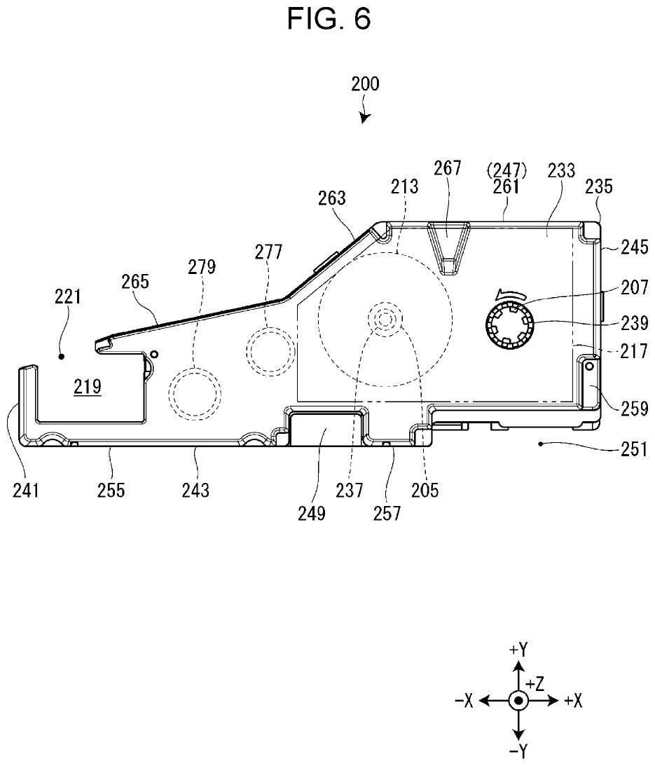

As shown in FIGS. 5 and 6, the front side case 227 includes a front side wall portion 233 and a first peripheral wall portion 235. The front side wall portion 233 is on the front side in the mounting direction when the ribbon cartridge 200 is mounted in the second cartridge mounting portion 7. The front side wall portion 233 is provided with a front side paying-out boss 237 and a front side winding opening 239. The front side paying-out boss 237 and the front side winding opening 239 are provided in the second ribbon core accommodating portion 217. The front side paying-out boss 237 and the front side winding opening 239 are respectively provided at positions corresponding to the second paying-out shaft 45 and the second winding shaft 47 provided in the second cartridge mounting portion 7. The front side paying-out boss 237 projects from the inner surface of the front side wall portion 233 toward the back side in the mounting direction and is engaged with the end portion of the second paying-out core 205 on the front side in the mounting direction. An end portion of the second winding core 207 on the front side in the mounting direction is engaged with the front side winding opening 239.

The first peripheral wall portion 235 extends from the peripheral edge portion of the front side wall portion 233 to the back side in the mounting direction. The first peripheral wall portion 235 includes a front side first wall portion 241 located on the −X side, a front side second wall portion 243 located on the −Y side, a front side third wall portion 245 located on the +X side, and a front side fourth wall portion 247 located on the +Y side. The second ribbon exposing portion 221 for exposing the second ink ribbon 213 is provided at a position where the front side first wall portion 241 and the front side fourth wall portion 247 intersect.

As shown in FIGS. 5 to 7, a second peripheral wall recessed portion 249 is provided at a substantially middle portion of the front side second wall portion 243 in the X direction. The second peripheral wall recessed portion 249 is formed in a shape that is recessed in a substantially rectangular shape that is slightly longer in the X direction when viewed from the front side in the mounting direction. The second peripheral wall recessed portion 249 is recessed in the front side second wall portion 243 over the entire mounting direction.

A fourth peripheral wall recessed portion 251 is provided at the +X side end portion of the front side second wall portion 243. The fourth peripheral wall recessed portion 251 is formed in a shape that is recessed in a substantially rectangular shape that is longer in the X direction when viewed from the front side in the mounting direction. Similar to the second peripheral wall recessed portion 249, the fourth peripheral wall recessed portion 251 is recessed in the front side second wall portion 243 over substantially the entire mounting direction. At the +X side end portion of the front side second wall portion 243, a substrate removal preventing portion 253 is provided on the end surface on the back side in the mounting direction so as to project toward the back side in the mounting direction. The substrate removal preventing portion 253 keeps the circuit substrate 311 attached to a substrate attaching portion 309 provided at the back side case 229 in a removal prevention state from the substrate attaching portion 309.

In the front side second wall portion 243, a first flat portion 255 located on the −X side of the second peripheral wall recessed portion 249 is substantially flush to a second flat portion 257 located between the second peripheral wall recessed portion 249 and the fourth peripheral wall recessed portion 251. If the second flat portion 257 is not provided, and the second peripheral wall recessed portion 249 and the fourth peripheral wall recessed portion 251 are connected to each other, the fourth peripheral wall recessed portion 251 located on the side of the center of gravity of the ribbon cartridge 200 may come into contact with the mounting surface, and the first flat portion 255 may be obliquely floated with respect to the mounting surface when the ribbon cartridge 200 is placed on the mounting surface such as a desk with the front side second wall portion 243 facing downward. In this case, the ribbon cartridge 200 is placed in a state in which it is easy to rattle the mounting surface. On the other hand, in the present embodiment, since the second flat portion 257 is provided, when the ribbon cartridge 200 is placed on the mounting surface with the front side second wall portion 243 facing downward, the second flat portion 257 abuts on the mounting surface. Therefore, the fourth peripheral wall recessed portion 251 is prevented from abutting on the mounting surface, and the first flat portion 255 is prevented from being in an obliquely floated state with respect to the mounting surface. Therefore, the ribbon cartridge 200 can be stably placed on the mounting surface.

As shown in FIGS. 5 and 6, a third peripheral wall recessed portion 259 is provided at the −Y side end portion of the front side third wall portion 245. The third peripheral wall recessed portion 259 is formed in a shape that is recessed in a substantially rectangular shape that is long in the Y direction when viewed from the front side in the mounting direction. The −Y side end portion of the third peripheral wall recessed portion 259 is connected with the +X side end portion of the fourth peripheral wall recessed portion 251. The third peripheral wall recessed portion 259 is recessed in the front side third wall portion 245 leaving an end portion on the back side in the mounting direction.

As shown in FIGS. 5, 6, and 8, the front side fourth wall portion 247 includes a front side first partial wall portion 261, a front side second partial wall portion 263, and a front side third partial wall portion 265. The front side first partial wall portion 261 extends from the +Y side end portion of the front side third wall portion 245 to the −X side. The front side second partial wall portion 263 is bent and extends from the −X side end portion of the front side first partial wall portion 261 in an oblique direction between the −X side and the −Y side. The front side third partial wall portion 265 is bent and extends from the −X side end portion of the front side second partial wall portion 263 at an angle closer to parallel to the X direction than the front side second partial wall portion 263.

The front side first partial wall portion 261 is provided with a first peripheral wall recessed portion 267. The first peripheral wall recessed portion 267 is formed in a shape that is recessed in a substantially trapezoidal shape that is long in the Y direction when viewed from the front side in the mounting direction. Similar to the third peripheral wall recessed portion 259, the front side fourth wall portion 247 of the first peripheral wall recessed portion 267 is recessed leaving the end portion on the back side in the mounting direction.

As shown in FIG. 9, the back side case 229 includes a back side wall portion 269 and a second peripheral wall portion 271. The back side wall portion 269 becomes the back side in the mounting direction when the ribbon cartridge 200 is mounted in the second cartridge mounting portion 7. The back side wall portion 269 faces the front side wall portion 233 of the front side case 227.

As shown in FIGS. 9 to 11, the back side wall portion 269 is provided with a back side paying-out opening 273, a back side winding opening 275, the paying-out side cylinder portion 277, the winding side cylinder portion 279, a first ribbon guide 281, a second ribbon guide 283, and a receiving insertion portion 285.

The back side paying-out opening 273 and the back side winding opening 275 are provided in the second ribbon core accommodating portion 217. The back side paying-out opening 273 and the back side winding opening 275 are respectively provided at positions corresponding to the second paying-out shaft 45 and the second winding shaft 47 provided in the second cartridge mounting portion 7. The back side paying-out opening 273 is engaged with the end portion of the second paying-out core 205 on the back side in the mounting direction. The back side winding opening 275 is engaged with the end portion of the second winding core 207 on the back side in the mounting direction. Hereinafter, the feeding direction of the second ink ribbon 213 is simply referred to as “feeding direction”. Further, in the feeding direction, the upstream side means the second paying-out core 205 side, and the downstream side means the second winding core 207 side.

The paying-out side cylinder portion 277 and the winding side cylinder portion 279 are located between the second ribbon core accommodating portion 217 and the second head insertion portion 219, and are provided so as to project from the back side wall portion 269 toward the front side in the mounting direction. The paying-out side cylinder portion 277 and the winding side cylinder portion 279 are respectively provided at positions corresponding to the first paying-out shaft 29 and the first winding shaft 31 provided in the overlapping region 21.

The paying-out side cylinder portion 277 is formed in a substantially cylindrical shape with a lid, and when the ribbon cartridge 200 is mounted in the second cartridge mounting portion 7, the first paying-out shaft 29 provided in the overlapping region 21 is inserted. As a result, when the ribbon cartridge 200 is mounted in the second cartridge mounting portion 7, the first paying-out shaft 29 is prevented from interfering with the ribbon cartridge 200. The paying-out side cylinder portion 277 has an inner diameter such that a gap is formed between the paying-out side cylinder portion 277 and the first paying-out rotation member 35 provided on the first paying-out shaft 29. Therefore, even if the first paying-out rotation member 35 rotates, the first paying-out rotation member 35 does not slide on the inner peripheral surface of the paying-out side cylinder portion 277. A press-fitting hole 287 into which a press-fitting pin (not shown) provided in the front side case 227 is press-fitted is provided on the front side of the paying-out side cylinder portion 277 in the mounting direction.

Further, the paying-out side cylinder portion 277 is located on the downstream side of the second paying-out core 205 in the feeding direction and guides the second ink ribbon 213 fed from the second paying-out core 205 to the second ribbon exposing portion 221. That is, the paying-out side cylinder portion 277 into which the first paying-out shaft 29 is inserted can also function as a guide member that guides the second ink ribbon 213. The paying-out side cylinder portion 277 may be configured by a cylinder portion provided in the front side case 227 and a cylinder portion provided in the back side case 229. However, in the present embodiment, the paying-out side cylinder portion 277 is provided only on one of the front side case 227 and the back side case 229, that is, only on the back side case 229. Therefore, it is possible to properly guide the second ink ribbon 213 without forming a step on the peripheral surface of the paying-out side cylinder portion 277. Further, the shape of the side cylinder portion 277 is not limited to the cylindrical shape, and may be, for example, an elliptic tubular shape, a semi-cylindrical shape or a rectangular tubular shape.

The winding side cylinder portion 279 is formed in a substantially cylindrical shape, and when the ribbon cartridge 200 is mounted in the second cartridge mounting portion 7, the first winding shaft 31 provided in the overlapping region 21 is inserted. This prevents the first winding shaft 31 from interfering with the ribbon cartridge 200 when the ribbon cartridge 200 is mounted in the second cartridge mounting portion 7. The winding side cylinder portion 279 has an inner diameter such that a gap is formed between the winding side cylinder portion 279 and the first winding rotation member 37 provided on the first winding shaft 31. Therefore, even if the first winding rotation member 37 rotates, the first winding rotation member 37 does not slide on the inner peripheral surface of the winding side cylinder portion 279.

Further, the winding side cylinder portion 279 is located on the downstream side of the second ribbon exposing portion 221 in the feeding direction and guides the second ink ribbon 213 fed from the second ribbon exposing portion 221 to the second winding core 207. That is, the winding side cylinder portion 279 into which the first winding shaft 31 is inserted can also function as a guide member that guides the second ink ribbon 213. The winding side cylinder portion 279 may be configured by a cylinder portion provided on the front side case 227 and a cylinder portion provided on the back side case 229. However, in the present embodiment, the winding side cylinder portion 279 is provided only on one of the front side case 227 and the back side case 229, that is, only on the back side case 229. Therefore, it is possible to properly guide the second ink ribbon 213 without forming a step on the peripheral surface of the winding side cylinder portion 279. Further, the shape of the winding side cylinder portion 279 is, similar to the shape of the paying-out side cylinder portion 277, not limited to the cylindrical shape, and may be, for example, an elliptic tubular shape, a semi-cylindrical shape, or a rectangular tubular shape.

The first ribbon guide 281 guides the second ink ribbon 213 at a position on the downstream side of the winding side cylinder portion 279 in the feeding direction of the second ink ribbon 213. The first ribbon guide 281 is formed integrally with the back side wall portion 269. The first ribbon guide 281 includes a first guide main body 289 and two first guide ribs 291. The first guide main body 289 is formed in a substantially columnar shape, comes into contact with the ink surface 213a of the second ink ribbon 213, and guides the second ink ribbon 213. The two first guide ribs 291 project from the peripheral surface of the first guide main body 289 toward the +X side and the −Y side. The first guide rib 291 prevents the first guide main body 289 from tilting due to the pressure received from the second ink ribbon 213 fed in an appropriately stretched state.

The second ribbon guide 283 guides the second ink ribbon 213 at a position on the downstream side of the first ribbon guide 281 in the feeding direction. The second ribbon guide 283 is formed integrally with the back side wall portion 269. Similar to the first ribbon guide 281, the second ribbon guide 283 includes a second guide main body 293 and two second guide ribs 295. The second guide main body 293 is formed in a substantially columnar shape, comes into contact with the surface of the second ink ribbon 213 opposite to the ink surface 213a, and guides the second ink ribbon 213. The two second guide ribs 295 project from the peripheral surface of the second guide main body 293 toward the −X side and the +Y side. The second guide rib 295 prevents the second guide main body 293 from tilting due to the pressure received from the second ink ribbon 213.

The receiving insertion portion 285 is located at the +X side and −Y side corner of the back side wall portion 269 and is provided so as to project toward the front side in the mounting direction. The receiving insertion portion 285 is provided with the receiving insertion hole 297 penetrating in the mounting direction. The receiving portion 51 is inserted into the receiving insertion hole 297 when the ribbon cartridge 200 is mounted in the second cartridge mounting portion 7.

The second peripheral wall portion 271 extends from the peripheral edge portion of the back side wall portion 269 toward the front side in the mounting direction. The end surface of the second peripheral wall portion 271 on the front side in the mounting direction is in contact with the end surface of the first peripheral wall portion 235 of the front side case 227 on the back side in the mounting direction. The second peripheral wall portion 271 includes a back side first wall portion 299 located on the −X side, a back side second wall portion 301 located on the −Y side, a back side third wall portion 303 located on the +X side, and a back side fourth wall portion 305 located on the +Y side. The second ribbon exposing portion 221 is provided at a position where the back side first wall portion 299 and the back side fourth wall portion 305 intersect.

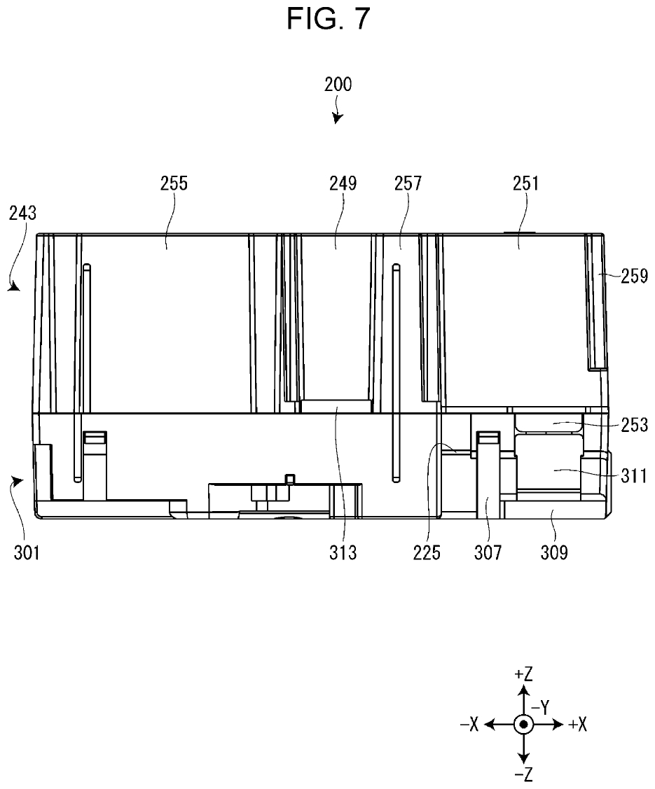

As shown in FIGS. 7 and 9 to 11, a back side peripheral wall recessed portion 307 is provided at the +X side end portion of the back side second wall portion 301 corresponding to the fourth peripheral wall recessed portion 251. Similar to the fourth peripheral wall recessed portion 251, the back side peripheral wall recessed portion 307 is formed in a shape that is recessed in a substantially rectangular shape that is long in the X direction when viewed from the front side in the mounting direction. The substrate attaching portion 309 is provided in the +X side and +Y side regions of the back side peripheral wall recessed portion 307. The circuit substrate 311 is attached to the substrate attaching portion 309. The circuit substrate 311 includes a storage element. Information such as the width of the second ink ribbon 213 and the remaining amount of the second ink ribbon 213 wound around the second paying-out core 205 is stored in the storage element. Further, since the substrate attaching portion 309 is provided in the +X side and +Y side regions of the back side peripheral wall recessed portion 307, the circuit substrate 311 attached to the substrate attaching portion 309 is prevented from abutting on the floor surface or the like even when the ribbon cartridge 200 is accidentally dropped, for example. This can prevent the circuit substrate 311 from being scratched or soiled.

A peripheral wall projecting portion 313 projecting from the end surface on the front side in the mounting direction toward the front side in the mounting direction is provided at a substantially middle portion of the back side second wall portion 301 in the X direction, that is, at a position corresponding to the second peripheral wall recessed portion 249. The peripheral wall projecting portion 313 is inserted into the second peripheral wall recessed portion 249 from the back side in the mounting direction.

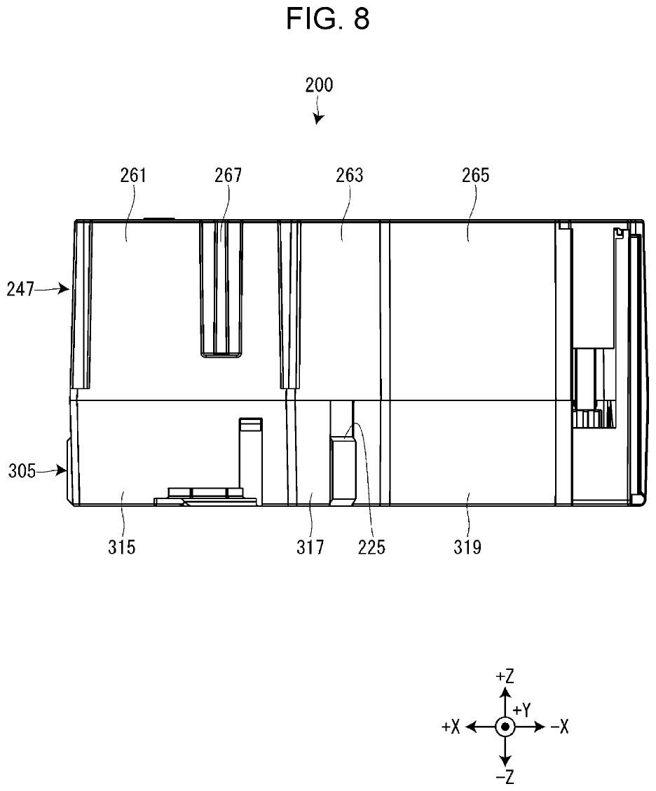

As shown in FIGS. 8, 10, and 11, the back side fourth wall portion 305 includes a back side first partial wall portion 315, a back side second partial wall portion 317, and a back side third partial wall portion 319. The back side first partial wall portion 315 extends from the +Y side end portion of the back side third wall portion 303 to the −X side. The back side second partial wall portion 317 is bent and extends from the −X side end portion of the back side first partial wall portion 315 in an oblique direction between the −X side and the −Y side. The back side third partial wall portion 319 is bent and extends from the −X side end portion of the back side second partial wall portion 317 at an angle closer to parallel to the X direction than the back side second partial wall portion 317.

As shown in FIGS. 5 and 7 to 9, the second hook engaging portion 225 is provided at the back side second wall portion 301, the back side third wall portion 303, and the back side second partial wall portion 317. That is, the three second hook engaging portions 225 are provided on the peripheral edge portion of the second ribbon core accommodating portion 217 when viewed from the front side in the mounting direction. The second hook 49 is engaged with the second hook engaging portion 225 when the ribbon cartridge 200 is mounted in the second cartridge mounting portion 7. As a result, the ribbon cartridge 200 is prevented from being mounted in a state of floating from the bottom surface of the second cartridge mounting portion 7.

### [Substrate Attaching Portion and Receiving Insertion Portion]

The substrate attaching portion 309 and the receiving insertion portion 285 provided in the ribbon cartridge 200 will be described together with the substrate connecting portion 53 and the receiving portion 51 provided in the second cartridge mounting portion 7.

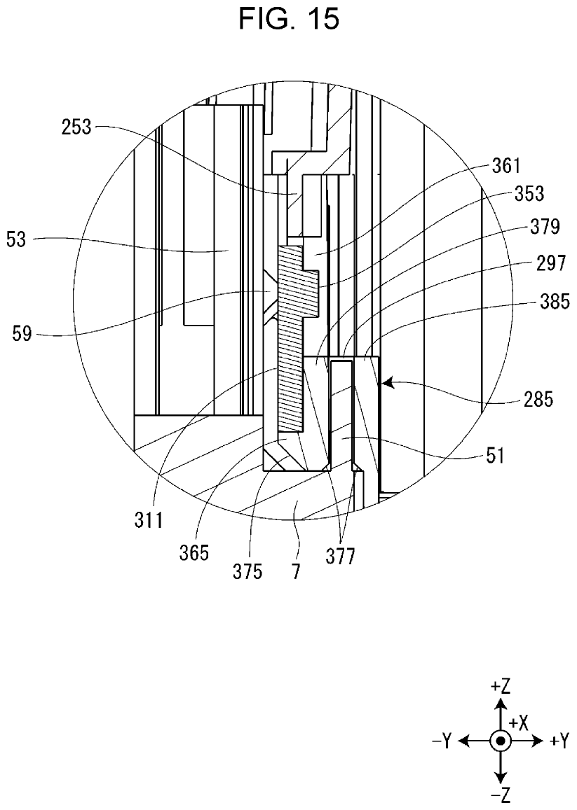

As shown in FIG. 4, the substrate connecting portion 53 is provided on the −Y side inner peripheral surface of the second cartridge mounting portion 7. The substrate connecting portion 53 includes a plurality of elastic contact portions 59 that are elastically displaceable in the Y direction (see FIG. 15). The elastic contact portion 59 is elastically displaced according to the contact pressure. That is, the elastic contact portion 59 projects in the +Y direction when not receiving an external force, and is elastically displaced in the −Y direction by receiving the external force. The Y direction is an example of the “first direction” of the present invention. The +Y side is an example of the “one side in the first direction” of the present invention. The −Y side is an example of the “other side in the first direction” of the present invention.

The receiving portion 51 is located on the +Y side with respect to the substrate connecting portion 53, and projects from the bottom surface of the second cartridge mounting portion 7 toward the front side in the mounting direction. The receiving portion 51 is formed in a substantially rectangular shape that is long in the X direction when viewed from the front side in the mounting direction.

As shown in FIG. 9, the substrate attaching portion 309 is provided at the +X side end portion of the back side second wall portion 301. The circuit substrate 311 is attached to the substrate attaching portion 309. On the −Y side surface of the circuit substrate 311, a plurality of connection terminals (not shown) with which a plurality of elastic contact portions 59 come into contact from the −Y side are provided. That is, the circuit substrate 311 is located between the substrate connecting portion 53 and the receiving portion 51 in the Y direction and is brought into contact with the elastic contact portion 59 when the ribbon cartridge 200 is mounted in the second cartridge mounting portion 7. The number of connection terminals is not particularly limited and may be one. The same applies to the number of elastic contact portions 59. A substrate projecting portion 353 is provided on the +Y side surface of the circuit substrate 311 (see FIG. 15).

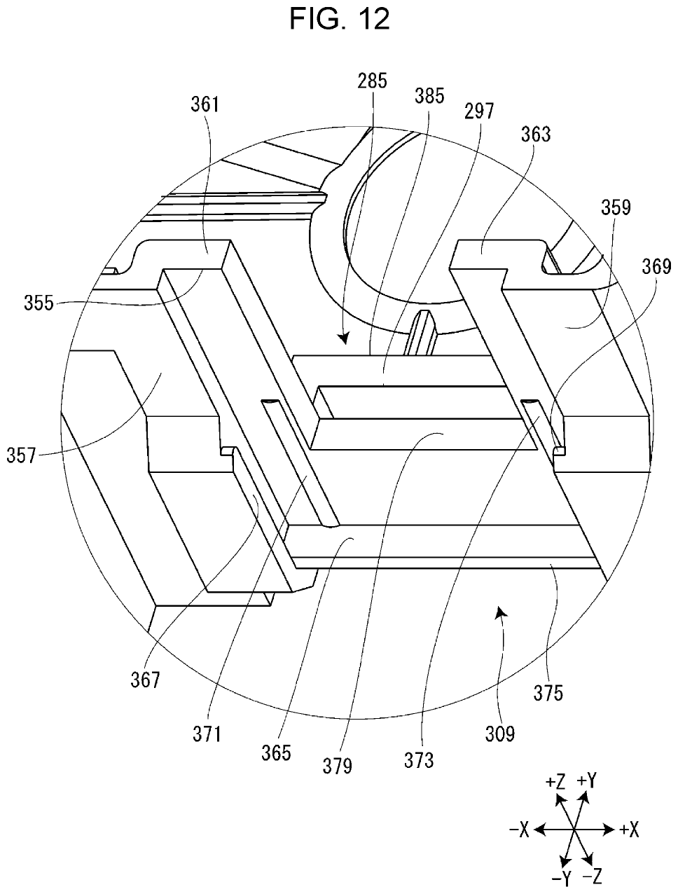

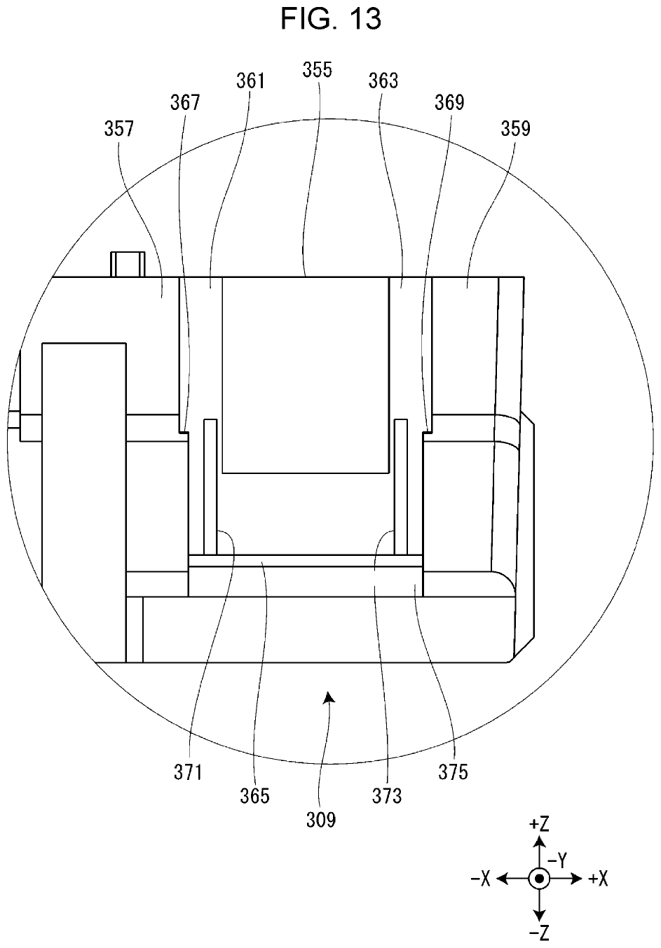

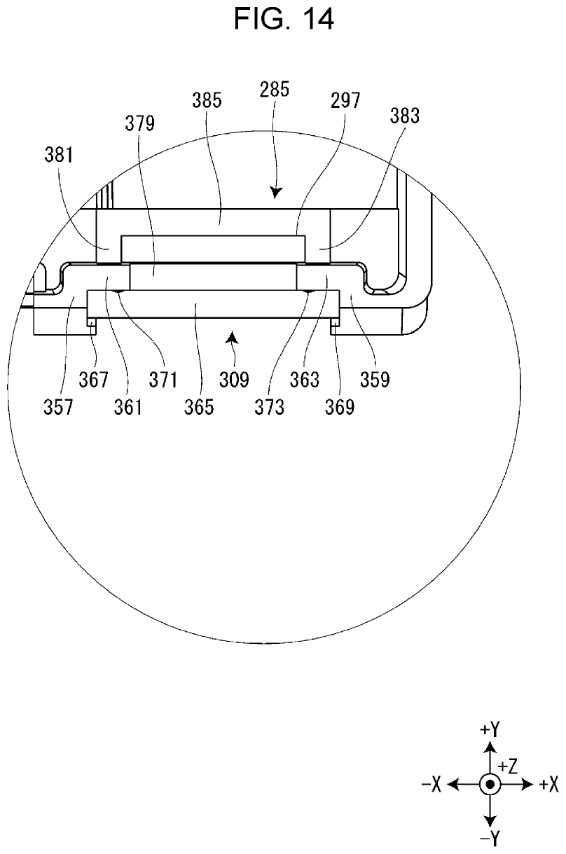

The substrate attaching portion 309 and the receiving insertion portion 285 will be described with reference to FIGS. 12 to 15. The substrate attaching portion 309 is formed in a substantially rectangular concave shape that is long in the X direction when viewed from the front side in the mounting direction, and is open on the front side in the mounting direction, the −Y side, and the +Y side. An open portion of the substrate attaching portion 309 on the front side in the mounting direction serves as a substrate insertion port 355 into which the circuit substrate 311 is inserted from the front side in the mounting direction. The front side in the mounting direction is an example of the “one side in the third direction” of the present invention.

The substrate attaching portion 309 includes a first attaching wall portion 357 located on the −X side, a second attaching wall portion 359 located on the +X side, a third attaching wall portion 361 and a fourth attaching wall portion 363 located on the +Y side with respect to the attached circuit substrate 311, and a fifth attaching wall portion 365 located on the back side in the mounting direction are provided.

The distance between the first attaching wall portion 357 and the second attaching wall portion 359 is formed to be much larger than the dimension of the circuit substrate 311 in the X direction such that there is no gap between the inserted circuit substrate 311 and the first attaching wall portion 357 or the second attaching wall portion 359. Therefore, the circuit substrate 311 is positioned in the X direction with respect to the substrate attaching portion 309 by the first attaching wall portion 357 and the second attaching wall portion 359. This can prevent the connection terminal of the circuit substrate 311 from being displaced in the X direction with respect to the elastic contact portion 59 of the substrate connecting portion 53.

A first substrate contact portion 367 is provided on the +X side surface of the first attaching wall portion 357 so as to project from the −Y side end portion toward the +X side. Similarly, a second substrate contact portion 369 is provided on the −X side surface of the second attaching wall portion 359 so as to project from the −Y side end portion toward the −X side.

The third attaching wall portion 361 is bent and extends from the end portion of the first attaching wall portion 357 on the +Y side toward the +X side. The fourth attaching wall portion 363 is bent and extends from the end portion of the second attaching wall portion 359 on the +Y side toward the −X side. A first insertion wall portion 379 of a receiving portion 51, which will be described later, connects a substantially half portion of the third attaching wall portion 361 on the back side in the mounting direction and a substantially half portion of the fourth attaching wall portion 363 on the back side in the mounting direction. A substrate projecting portion 353 of the attached circuit substrate 311 is located in a gap between a substantially half portion of the third attaching wall portion 361 on the front side in the mounting direction and a substantially half portion of the fourth attaching wall portion 363 on the front side in the mounting direction.

A first positioning projecting portion 371 is provided on the −Y side surface of the third attaching wall portion 361 so as to project toward the −Y side. The first positioning projecting portion 371 projects from the third attaching wall portion 361 in a substantially arc shape when viewed from the front side in the mounting direction, and is formed in a substantially rectangular shape elongated in the mounting direction when viewed from the −Y side. Similarly, a second positioning projecting portion 373 is provided on the −Y side surface of the fourth attaching wall portion 363 so as to project toward the −Y side. The second positioning projecting portion 373 projects from the fourth attaching wall portion 363 in a substantially arc shape when viewed from the front side in the mounting direction, and is formed in a substantially rectangular shape elongated in the mounting direction when viewed from the −Y side. The distance between the first positioning projecting portion 371 and the second positioning projecting portion 373, and the first substrate contact portion 367 and the second substrate contact portion 369 is substantially the same as the thickness of the circuit substrate 311 so that the circuit substrate 311 can be press-fitted.

The fifth attaching wall portion 365 is provided so as to connect the end portion of the first attaching wall portion 357 on the back side in the mounting direction and the end portion of the second attaching wall portion 359 on the back side in the mounting direction. The −Y side surface of the fifth attaching wall portion 365 and the −Y side surface of the attached circuit substrate 311 are substantially flush with each other. An attaching side chamfer portion 375 is provided at a corner of the fifth attaching wall portion 365 on the −Y side and on the back side in the mounting direction. When the ribbon cartridge 200 is mounted in the second cartridge mounting portion 7, the elastic contact portion 59 of the substrate connecting portion 53 is suppressed from being caught on the corner on the −Y side of the fifth attaching wall portion 365 and back side in the mounting direction by the attaching side chamfer portion 375.

Here, a method of attaching the circuit substrate 311 to the substrate attaching portion 309 will be described. First, before the front side case 227 and the back side case 229 are combined, the circuit substrate 311 is inserted from the substrate insertion port 355 of the substrate attaching portion 309 provided in the back side case 229.

At this time, until the end portion on the back side of the circuit substrate 311 in the mounting direction abuts on the first positioning projecting portion 371 and the second positioning projecting portion 373 and then abuts on the fifth attaching wall portion 365, the circuit substrate 311 is inserted so as to be press-fitted between the first positioning projecting portion 371 and the second positioning projecting portion 373, and the first substrate contact portion 367 and the second substrate contact portion 369. Therefore, the −Y side surface of the circuit substrate 311, that is, the surface on which the connection terminals are provided, comes into contact with the +Y side surfaces of the first substrate contact portion 367 and the second substrate contact portion 369. In other words, the circuit substrate 311 is positioned in the Y direction by the first positioning projecting portion 371 and the second positioning projecting portion 373 so that the −Y side surface of the circuit substrate 311 comes into contact with the +Y side surfaces of the first substrate contact portion 367 and the second substrate contact portion 369. The third attaching wall portion 361 and the fourth attaching wall portion 363 are examples of the “attaching wall portion” of the present invention. The first substrate contact portion 367 and the second substrate contact portion 369 are examples of the “substrate contact portion” in the present invention. The first positioning projecting portion 371 and the second positioning projecting portion 373 are examples of the “substrate positioning portion” of the present invention.

After the circuit substrate 311 is inserted into the substrate attaching portion 309, the front side case 227 and the back side case 229 are combined. As a result, the substrate removal preventing portion 253 provided on the front side case 227 is located on the front side in the mounting direction of the circuit substrate 311 interposing a slight gap between the substrate removal preventing portion 253 and the circuit substrate 311 inserted in the substrate attaching portion 309. The circuit substrate 311 is kept in a removal prevention state with respect to the substrate attaching portion 309 by the substrate removal preventing portion 253. In this way, the circuit substrate 311 is attached to the substrate attaching portion 309. The front side case 227 is an example of the “first case” of the present invention. The back side case 229 is an example of the “second case” of the present invention.

The receiving insertion portion 285 is located on the +Y side of the substrate attaching portion 309, and is provided so as to project from the back side wall portion 269 toward the front side in the mounting direction in a substantially rectangular tubular shape. The receiving insertion portion 285 is provided with a receiving insertion hole 297 into which the receiving portion 51 is inserted when the ribbon cartridge 200 is mounted in the second cartridge mounting portion 7. The receiving insertion hole 297 is formed in a substantially rectangular shape complementary to the receiving portion 51 when viewed from the front side in the mounting direction. An insertion side chamfer portion 377 is formed at the peripheral edge portion of the receiving insertion hole 297 on the back side in the mounting direction. The insertion side chamfer portion 377 allows the receiving portion 51 to be smoothly inserted into the receiving insertion hole 297 when the ribbon cartridge 200 is mounted in the second cartridge mounting portion 7.

The receiving insertion portion 285 includes a first insertion wall portion 379 located on the −Y side, a second insertion wall portion 381 located on the −X side, a third insertion wall portion 383 located on the +X side, and a fourth insertion wall portion 385 located on the +Y side with respect to the receiving insertion hole 297. The second insertion wall portion 381 and the third insertion wall portion 383 are provided to face each other in the X direction. The X direction is an example of the “second direction” of the present invention. The first insertion wall portion 379 is an example of a “receiving contact portion” of the present invention.

The first insertion wall portion 379 is located between the circuit substrate 311 and the receiving portion 51 in the Y direction when the ribbon cartridge 200 is mounted in the second cartridge mounting portion 7. As described above, the first insertion wall portion 379 is connected with the third attaching wall portion 361 and the fourth attaching wall portion 363 of the substrate attaching portion 309. The distance between the first insertion wall portion 379 and the fourth insertion wall portion 385 is formed to be larger than the dimension of the receiving portion 51 in the Y direction such that a gap is generated between the inserted receiving portion 51 and the fourth insertion wall portion 385. On the other hand, the distance between the second insertion wall portion 381 and the third insertion wall portion 383 is to be much larger than the dimension of the receiving portion 51 in the X direction such that there is no gap between the inserted receiving portion 51 and the second insertion wall portion 381 or the third insertion wall portion 383. Therefore, the receiving insertion portion 285 is positioned in the X direction with respect to the receiving portion 51 by the second insertion wall portion 381 and the third insertion wall portion 383. This can prevent the connection terminal of the circuit substrate 311 from being displaced in the X direction with respect to the elastic contact portion 59 of the substrate connecting portion 53.

When the ribbon cartridge 200 configured as described above is mounted in the second cartridge mounting portion 7, first, the attaching side chamfer portion 375 of the fifth attaching wall portion 365 abuts on the elastic contact portion 59 of the substrate connecting portion 53. When the ribbon cartridge 200 further advances to the back side in the mounting direction, the ribbon cartridge 200 displaces the elastic contact portion 59 toward the −Y side against the elastic force of the elastic contact portion 59, and the fifth attaching wall portion 365, the circuit substrate 311, and the connection terminal come into contact with the elastic contact portions 59 in this order. The connection terminal is formed to be long in the Z direction, and advances to the back side in the mounting direction integrally with the circuit substrate 311, eventually the ribbon cartridge 200 while sliding the elastic contact portion 59 on the surface of the connection terminal. Then, when the ribbon cartridge 200 abuts on the bottom surface of the second cartridge mounting portion 7, the elastic contact portion 59 is held in a state of being in contact with the connection terminal of the circuit substrate 311. At this time, the receiving portion 51 is inserted into the receiving insertion portion 285. In this state, the circuit substrate 311 is pressed to the +Y side, that is, the receiving portion 51 side by the elastic force of the elastic contact portion 59, so that the first insertion wall portion 379 comes into contact with the receiving portion 51 from the −Y side. As a result, the elastic force of the elastic contact portion 59 is received by the receiving portion 51 via the circuit substrate 311, the substrate attaching portion 309, and the receiving insertion portion 285.

Therefore, the second cartridge case 209 to which the circuit substrate 311 is attached is suppressed from rotating by receiving the elastic force of the elastic contact portion 59, and the second cartridge case 209 is suppressed from being tilted with respect to the bottom surface of the second cartridge mounting portion 7. As a result, the second paying-out core 205 and the second winding core 207 accommodated in the second cartridge case 209 are suppressed from being tilted with respect to the second paying-out shaft 45 and the second winding shaft 47. Therefore, when the second ink ribbon 213 is fed from the second paying-out core 205 to the second winding core 207, it is possible to suppress wrinkles from occurring in the second ink ribbon 213. Similarly, when the second ink ribbon 213 is rewound from the second winding core 207 to the second paying-out core 205, it is possible to suppress wrinkles from occurring in the second ink ribbon 213.

Further, as described above, the circuit substrate 311 is positioned in the Y direction with respect to the substrate attaching portion 309 such that the −Y side surface of the circuit substrate 311 comes into contact with the first substrate contact portion 367 and the second substrate contact portion 369. The substrate attaching portion 309 to which the circuit substrate 311 is attached is positioned in the Y direction with respect to the receiving portion 51 by the first insertion wall portion 379 of the receiving insertion portion 285 coming into contact with the receiving portion 51 from the −Y side. Therefore, it is possible to reduce variation in the distance between the substrate connecting portion 53 and the −Y side surface of the circuit substrate 311. As a result, the amount of displacement of the elastic contact portion 59 can be reduced, so that the force with which the elastic contact portion 59 presses the circuit substrate 311 can be reduced, and the durability of the elastic contact portion 59 for the attaching and detaching operation of the ribbon cartridge 200 can be improved.

As described above, the ribbon cartridge 200 of this embodiment includes the second cartridge case 209, the substrate attaching portion 309, the circuit substrate 311, and the receiving insertion portion 285. The second cartridge case 209 accommodates the second ink ribbon 213. The substrate attaching portion 309 is provided at the second cartridge case 209. The circuit substrate 311 is attached to the substrate attaching portion 309. The circuit substrate 311 is pressed to the +Y side by the elastic force of the elastic contact portion 59 that contacts from the −Y side when the ribbon cartridge 200 is mounted in the second cartridge mounting portion 7. The receiving insertion portion 285 is provided on the +Y side with respect to the circuit substrate 311, and contacts the receiving portion 51 from the −Y side when the ribbon cartridge 200 is mounted in the second cartridge mounting portion 7.

Further, the tape printing device P of the present embodiment includes the second cartridge mounting portion 7, the substrate connecting portion 53, and the receiving portion 51. The ribbon cartridge 200 is mounted on the second cartridge mounting portion 7. The substrate connecting portion 53 has an elastic contact portion 59 that is elastically displaceable in the Y direction. The substrate connecting portion 53 is provided in the second cartridge mounting portion 7, and when the ribbon cartridge 200 is mounted in the second cartridge mounting portion 7, the substrate connecting portion 53 presses the circuit substrate 311 to the +Y side by an elastic force of an elastic contact portion 59 that comes into contact with the circuit substrate 311 from the −Y side. The receiving portion 51 is provided in the second cartridge mounting portion 7 and is located on the +Y side with respect to the substrate connecting portion 53. When the ribbon cartridge 200 is mounted in the second cartridge mounting portion 7, the receiving insertion portion 285 that contacts from the −Y side is received.

According to this configuration, the elastic force of the elastic contact portion 59 is received by the receiving portion 51 via the circuit substrate 311, the substrate attaching portion 309, and the receiving insertion portion 285. Therefore, the second cartridge case 209 to which the circuit substrate 311 is attached is suppressed from rotating by receiving the elastic force of the elastic contact portion 59, and the second cartridge case 209 is suppressed from being tilted with respect to the bottom surface of the second cartridge mounting portion 7. Therefore, the ribbon cartridge 200 can be properly mounted in the second cartridge mounting portion 7.

### Modification Example

It is needless to say that the present invention is not limited to the above embodiment and various configurations can be adopted without departing from the spirit of the present invention. For example, the above embodiment can be modified into the following forms in addition to the above.

The portion of the second cartridge case 209 that comes into contact with the receiving portion 51 is not limited to the first insertion wall portion 379 that constitutes the receiving insertion portion 285, and may be another portion of the second cartridge case 209. That is, the second cartridge case 209 need only be provided with a portion that comes into contact with the receiving portion 51, and does not need to be provided with a portion into which the receiving portion 51 is inserted. Furthermore, the circuit substrate 311 may be brought into direct contact with the receiving portion 51. That is, the circuit substrate 311 may function as the “receiving contact portion” of the present invention.

The configuration in which the first positioning projecting portion 371 and the second positioning projecting portion 373 are provided on the first insertion wall portion 379 side, and the first substrate contact portion 367 and the second substrate contact portion 369 are provided on the substrate connecting portion 53 side is not limited, and this may be reversed. That is, the first positioning projecting portion 371 and the second positioning projecting portion 373 may be provided on the substrate connecting portion 53 side, and the first substrate contact portion 367 and the second substrate contact portion 369 may be provided on the first insertion wall portion 379 side.

The “print cartridge” of the present invention is also applicable to the tape cartridge 100 of the present embodiment. That is, the tape cartridge 100 may have the same configurations as the substrate attaching portion 309, the circuit substrate 311, and the receiving insertion portion 285 of the present embodiment. The circuit substrate included in the tape cartridge 100 stores information such as the width of the first tape 111 and the remaining amount of the first tape 111 wound around the tape core 101. Further, the tape printing device P may have the same configuration as the substrate connecting portion 53 and the receiving portion 51 of the present embodiment in the first cartridge mounting portion 5 in which the tape cartridge 100 is mounted. This prevents the first cartridge case 109 from tilting with respect to the bottom surface of the first cartridge mounting portion 5. Therefore, the tape cartridge 100 can be properly mounted in the first cartridge mounting portion 5. Therefore, it is possible to prevent wrinkles from occurring in the first ink ribbon 113. As described above, the “print cartridge” of the present invention may be configured to accommodate a tape-shaped print medium such as the first tape 111 in addition to the first ink ribbon 113, like the tape cartridge 100. Furthermore, the “print cartridge” of the present invention may be configured to accommodate a tape-shaped print medium instead of the ink ribbon. That is, the “tape-shaped member” of the present invention is not limited to the ink ribbon such as the second ink ribbon 213, and may be a tape-shaped print medium such as the first tape 111, for example.

Further, the “tape guide” of the present invention may be applied to the tape guide 400 of the present embodiment. That is, the tape guide 400 may have the same configurations as the substrate attaching portion 309, the circuit substrate 311, and the receiving insertion portion 285 of the present embodiment. The circuit substrate included in the tape guide 400 stores information such as the width of the second tape 500 and the remaining amount of the second tape 500 in the tape roll. Further, the tape printing device P may have the same configuration as the substrate connecting portion 53 and the receiving portion 51 of the present embodiment in the first non-overlapping region 23 of the first cartridge mounting portion 5 in which the tape guide 400 is mounted. As a result, the tape guide 400 is prevented from being mounted in a tilted posture with respect to the bottom surface of the first cartridge mounting portion 5. Therefore, the tape guide 400 can be properly mounted in the first cartridge mounting portion 5. Therefore, the second tape 500 can be properly guided.

### REFERENCE SIGNS LIST

7 second cartridge mounting portion
51 receiving portion
53 substrate connecting portion
59 elastic contact portion
109 first cartridge case
209 second cartridge case
253 substrate removal preventing portion
285 receiving insertion portion
297 receiving insertion hole
309 substrate attaching portion
311 circuit substrate
353 substrate projecting portion
361 third attaching wall portion
365 fifth attaching wall portion
375 attaching side chamfer portion
377 insertion side chamfer portion
379 first insertion wall portion
385 fourth insertion wall portion

1. A print cartridge to be mounted in a printing device including
a cartridge mounting portion in which the print cartridge is mounted,
a substrate connecting portion having an elastic contact portion that is elastically displaceable in a first direction and provided in the cartridge mounting portion, and
a receiving portion provided in the cartridge mounting portion and, which is located along the first direction with respect to the substrate connecting portion, the print cartridge comprising:
a cartridge case accommodating a tape-shaped member;
a substrate attaching portion provided on the cartridge case;
a circuit substrate that is attached to the substrate attaching portion, is located between the substrate connecting portion and the receiving portion, is brought into contact with the elastic contact portion, and is pressed to the receiving portion side by an elastic force of the elastic contact portion in the first direction when the print cartridge is mounted in the cartridge mounting portion; and
a receiving contact portion that is located between the circuit substrate and the receiving portion and comes into contact with the receiving portion in the first direction when the print cartridge is mounted in the cartridge mounting portion.

2. The print cartridge according to claim 1, wherein
the cartridge case has a receiving insertion portion provided with a receiving insertion hole into which the receiving portion is inserted when the print cartridge is mounted in the cartridge mounting portion, and
the receiving insertion portion has a first insertion wall portion which is provided between the receiving insertion hole and the circuit substrate in the first direction when the print cartridge is mounted in the cartridge mounting portion and which functions as the receiving contact portion.

3. The print cartridge according to claim 1, wherein
the circuit substrate functions as the receiving contact portion that comes into contact with the receiving portion.

4. The print cartridge according to claim 2, wherein
the receiving insertion portion includes
a second insertion wall portion and a third insertion wall portion provided to face each other in a second direction intersecting the first direction with respect to the receiving insertion hole, and
the second insertion wall portion and the third insertion wall portion position the receiving insertion portion with respect to the receiving portion in the second direction.

5. The print cartridge according to claim 1, wherein
the substrate attaching portion is provided with a substrate positioning portion that positions the circuit substrate in the first direction.

6. The print cartridge according to claim 5, wherein
the substrate attaching portion is provided with a substrate insertion port into which the circuit substrate is inserted from one side in a third direction intersecting the first direction,
the substrate attaching portion includes
an attaching wall portion located on either the receiving contact portion side or the substrate connecting portion side in the first direction with respect to the circuit substrate inserted from the substrate insertion port, and
a substrate contact portion located on an opposite side of the attaching wall portion in the first direction with respect to the circuit substrate inserted from the substrate insertion port, and
the substrate positioning portion is provided in the attaching wall portion to project to a side on which the substrate contact portion is provided in the first direction.

7. The print cartridge according to claim 1, wherein
the substrate attaching portion is provided with a substrate insertion port into which the circuit substrate is inserted from one side in a third direction intersecting the first direction.

8. The print cartridge according to claim 7, wherein
the cartridge case has a first case and a second case,
the substrate attaching portion is provided in the second case, and
a substrate removal preventing portion for preventing the circuit substrate attached to the substrate attaching portion from being removed from the substrate attaching portion is provided in the first case.

9. The print cartridge according to claim 1, wherein
the tape-shaped member is an ink ribbon.

10. A tape guide mounted in a printing device including
a guide mounting portion in which the tape guide is mounted,
a substrate connecting portion having an elastic contact portion that is elastically displaceable in a first direction and provided in the guide mounting portion, and
a receiving portion which is located along the first direction with respect to the substrate connecting portion and provided in the guide mounting portion, the tape guide comprising:
a guide portion for guiding the tape-shaped member;
a substrate attaching portion;
a circuit substrate that is attached to the substrate attaching portion, is located between the substrate connecting portion and the receiving portion, is brought into contact with the elastic contact portion, and is pressed to the receiving portion side by an elastic force of the elastic contact portion in the first direction when the tape guide is mounted in the guide mounting portion; and
a receiving contact portion that is located between the circuit substrate and the receiving portion and comes into contact with the receiving portion in the first direction when the tape guide is mounted in the guide mounting portion.

11. A printing device in which a print cartridge with a cartridge case accommodating a tape-shaped member, a substrate attaching portion provided in the cartridge case, a circuit substrate attached to the substrate attaching portion, and a receiving contact portion provided along a first direction of the circuit substrate is mounted, the printing device comprising:
a cartridge mounting portion in which the print cartridge is mounted;
a substrate connecting portion having an elastic contact portion that is elastically displaceable in the first direction, provided in the cartridge mounting portion, and pressing the circuit substrate toward the receiving contact portion side in the first direction by an elastic force of the elastic contact portion that comes into contact with the circuit substrate in the first direction when the print cartridge is mounted in the cartridge mounting portion; and
a receiving portion that receives the receiving contact portion that is pushed by the elastic force of the elastic contact portion in the first direction when the print cartridge is mounted in the cartridge mounting portion.

12. A printing device in which a tape guide with a guide portion for guiding a tape-shaped member, a substrate attaching portion, a circuit substrate attached to the substrate attaching portion, and a receiving contact portion provided along a first direction of the circuit substrate is mounted, the printing device comprising:
a guide mounting portion in which the tape guide is mounted;
a substrate connecting portion having an elastic contact portion that is elastically displaceable in the first direction and provided in the guide mounting portion so as to push the circuit substrate toward the receiving contact portion side in the first direction by an elastic force of the elastic contact portion that comes into contact with the circuit substrate in the first direction when the tape guide is mounted in the guide mounting portion; and
a receiving portion that receives the receiving contact portion that is pressed by the elastic force of the elastic contact portion in the first direction when the tape guide is mounted in the guide mounting portion.
